(19) United States
(12) Patent Application Publication
(10) Pub. No.: US 2005/0044321 A1
(43) Pub. Date: Feb. 24, 2005

(54) Method and system for multiprocess cache management

(76) Inventors: Jan Bialkowski, San Jose, CA (US); Wing Cheung, Fremont, CA (US)

Correspondence Address: CARR & FERRELL LLP, 2200 GENG ROAD, PALO ALTO, CA, 94303, US

(21) Appl. No.: 10/921,002

(22) Filed: Aug. 17, 2004

Related U.S. Application Data
(60) Provisional application No. 60/496,045, filed on Aug. 18, 2003.

(51) Int. Cl. G06F 12/00

(52) U.S. Cl. 711/118; 711/167

(57) ABSTRACT

A cache management system in a multiprocessing computing system avoids blocking subsequent memory requests to access data in the cache after a previous memory request to access the data in the cache generates a cache miss and while the cache is being updated with the data. The previous memory request and subsequent memory requests are stored in a piggyback FIFO while the data is retrieved from a memory device. The cache is then updated with the data and the previous memory request and subsequent memory requests are processed on the cache.

### CROSS-REFERENCE TO RELATED APPLICATIONS

The present application claims the benefit of priority from U.S. Provisional Patent Application No. 60/496,045, filed on Aug. 18, 2003 and entitled “Method and System for Multiprocess Cache Management”, which is incorporated by reference herein.

### BACKGROUND

1. Field of the Invention

The present invention relates generally to multiprocessing computing systems, and more particularly to a system and method for cache management in a multiprocessing computing system.

2. Background Art

A multiprocessing computing system typically includes multiple processors that can concurrently execute multiple instructions. The processors are often connected to a main memory through a memory access queue, which allows multiple outstanding memory requests from the processors to the main memory. In this arrangement, the processors issue memory requests into one end of the memory access queue and the main memory processes the memory requests from the other end of the memory access queue. The main memory then returns data to the processors through a return data queue that is connected between the main memory and the processors.

The memory access queue is often a bottleneck in the performance of a multiprocessing computing system. As the memory access queue fills up with memory requests, the access time for memory requests increases. This increase in memory access time can result in reduced performance of the multiprocessing computing system. In particular, the performance of the multiprocessing computing system is reduced when the memory access queue is full and, as a result, processors cannot issue additional memory requests into the memory access queue (i.e., processors are stalled and memory requests are blocked).

It has been suggested that a cache be placed between the processor and the memory access queue of a multiprocessing computing system to improve the memory access time and, thus, increase the performance of the multiprocessing computing system. The effectiveness of the cache in improving performance may be reduced, however, when a memory request from a processor to the cache generates a cache miss, which results in a memory access to main memory through the memory access queue and data return queue to update the cache with data. Further, a subsequent memory request to access the data will also generate a cache miss and become blocked until the cache is updated with the data.

One way to avoid blocking subsequent memory requests to access the data when a cache miss occurs is to bypass the cache for the subsequent memory requests. This approach, however, results in a memory access to main memory for each subsequent memory request for the data until the cache is updated with the data. As a result, the effectiveness of the cache in improving performance of the multiprocess computing system is reduced. Additionally, a cache coherence scheme must be employed to maintain the coherency of the memory requests with both the main memory and the cache.

In light of the above, there exists a need for a cache that avoids blocking subsequent memory requests to access the data of a previous memory request while the cache is being updated with the data, and avoids accessing the data in the main memory for each of the subsequent memory requests.

### SUMMARY OF THE INVENTION

The present invention addresses the need for a cache that avoids blocking subsequent memory requests to access the data of a previous memory request while the cache is being updated with the data, and avoids accessing the data in the main memory for subsequent memory requests to access the data by providing a piggyback first-in first-out (FIFO) memory for temporarily storing the memory requests while the cache is being updated with the data. After the cache is updated with the data, the memory requests stored in the piggyback FIFO are processed on the cache.

A computing system incorporating the present invention includes a processor for issuing first and subsequent memory requests to a memory address, a cache and a memory device. The computing system also includes an associative memory for associating a sequence identifier with the memory requests, and a memory interface control for issuing an external memory request with the sequence identifier to the memory device. The computing system further includes a memory return control for receiving data and the sequence identifier from the memory device in response to the external memory request. The memory return control associates the first memory request with the data received from the memory device based on the sequence identifier received from the memory device. Additionally, the memory return control issues the first memory request with the data to the cache to update the cache with the data.

In operation, a first memory request to a memory address is received from a first computing process and is associated with a sequence identifier. A second memory request to the memory address is received from a second computing process and is associated with the sequence identifier. An external memory request with the sequence identifier is issued to a memory device, and data and the sequence identifier is received in response. The data is associated with the first memory request based on the sequence identifier received from the memory device and the cache is updated with the data for the first memory request. The first memory request is then processed on the data in the cache.

### BRIEF DESCRIPTION OF THE DRAWINGS

FIG. 1 is a block diagram of a computing system incorporating the present invention;

FIG. 2 is a block diagram of the memory request scheduler shown in FIG. 1;

FIG. 3 is a block diagram of the cache shown in FIG. 1;

FIG. 4is a block diagram of the memory interface shown in FIG. 1;

FIG. 5 is a flow chart of a portion of a method for managing the multiprocess cache system shown in FIG. 1, in accordance with the present invention; and

FIG. 6 is a flow chart of a portion of a method for managing the multiprocess cache system shown in FIG. 1, in accordance with the present invention.

### DETAILED DESCRIPTION OF THE PREFERRED EMBODIMENT

The present invention provides a system and method for managing a cache accessed by multiple computing processes. The computing processes issue memory requests to access data in the cache. When the data to be accessed by a memory request is not in the cache, the memory request is temporarily stored in a piggyback FIFO. Subsequent memory requests for the data are also temporarily stored in the piggyback FIFO. A memory interface issues an external memory request to a memory device containing the desired data. In response to the external memory request, the memory device returns the data to a memory return control. The memory return control then issues the memory request stored in the piggyback FIFO and the data to the cache. The cache is then updated with the data and the first memory request is processed on the cache. The memory return control then issues the next memory request stored in the piggyback FIFO to the cache for processing. This is repeated until the piggyback FIFO is empty. In this way, the number of external memory requests to the memory device is reduced in contrast to issuing an external memory request to the memory device for each memory request. Additionally, storing the subsequent memory requests in the piggyback FIFO avoids blocking these subsequent memory requests and prevents stalling the computing processes.

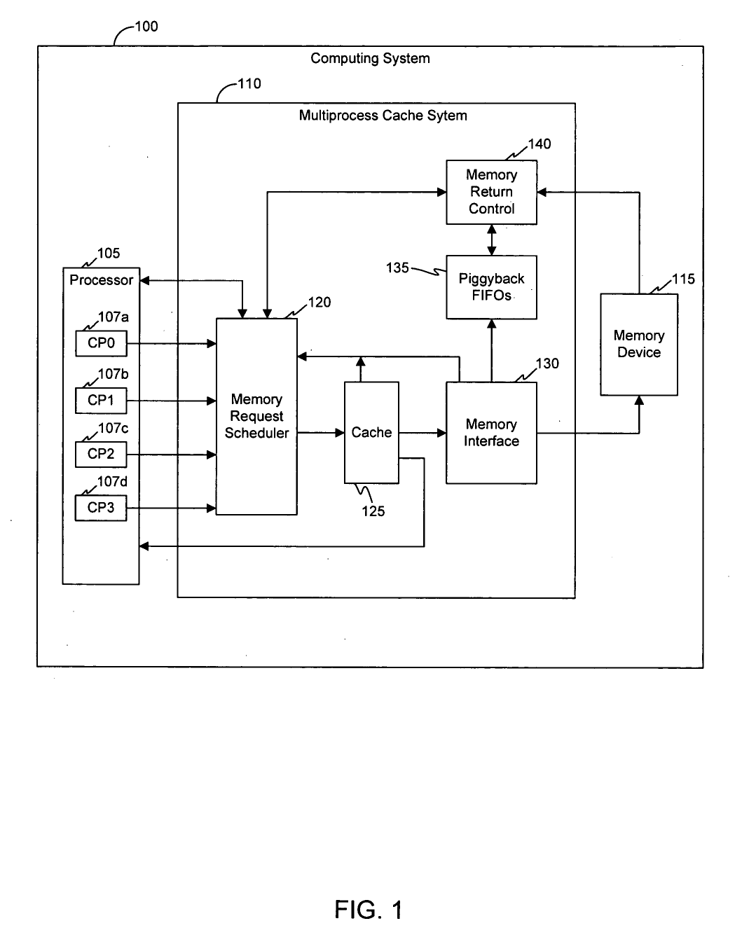

Referring now to FIG. 1, a computing system 100 incorporating the present invention is shown. The computing system 100 includes a processor 105 that issues memory requests. For example, the processor 105 can be a single processor that executes one or more processes or process threads. As another example, the processor 105 can be a single processor that has multiple execution pipelines for executing one or more processes or process threads. As a further example, the processor 105 can be a multiprocessor that includes multiple processing units that execute one or more processes or process threads.

The processor 105 includes one or more computing processes 107. Each computing process 107 can be a process or a process thread. It is to be understood that the computing processes 107a-d shown in the figure are exemplary and the present invention is not limited to having any particular number of computing processes 107.

The computing system 100 also includes a multiprocess cache system 110 and a memory device 115. The multiprocess cache system 110 communicates with both the processor 105 and the memory device 115. The processor 105 issues memory requests to access data in the multiprocess cache system 110. Depending upon the type of memory request issued by the processor 105 and whether the data to be accessed is in the cache 125, the multiprocess cache system 110 issues one or more external memory requests to the memory device 115. In response to an external memory request from the multiprocess cache system 110, the memory device 115 returns a response (e.g., data for a read operation or an acknowledgement for a write-ack operation) to the multiprocess cache system 110. In turn, the multiprocess cache system 110 can return the response (e.g., data or acknowledgement) to the processor 105.

The multiprocess cache system 110 includes a memory request scheduler 120, a cache 125 and one or more piggyback FIFOs 135. The memory request scheduler 120 receives memory requests from the processor 105 and determines the order in which the memory requests are to be issued to the cache 125. If the data to be accessed by the memory request is not in the cache 125 (e.g., cache miss), the cache 125 issues a memory request to a memory interface 130. For example, the cache 125 can issue a memory request to the memory interface 130 if a cache miss occurs or if the memory request is specifically directed to the memory device 115 (e.g., bypass cache operation).

The memory interface 130 associates a sequence identifier with the memory request received from the cache 125, as is explained more fully herein. In turn, the memory interface 130 issues an external memory request, which includes the sequence identifier, to the memory device 115 to access data for the memory request. Additionally, the memory interface 130 issues the memory request to the piggyback FIFOs 135, each of which is associated with a sequence identifier. The piggyback FIFO 135 associated with the sequence identifier (which is itself associated with the memory request) receives and stores the memory request.

The multiprocess cache system 110 also includes a memory return control 140 that communicates with the memory device 115 and the piggyback FIFOs 135. In response to an external memory request received from the memory interface 130, the memory device 115 provides a response (e.g., data for a read operation or an acknowledgement for a write-ack operation) and the sequence identifier associated with the external memory request to the memory return control 140. Based on the sequence identifier received from the memory device 115, the memory return control 140 associates the response (e.g., data or acknowledgement) with the piggyback FIFO 135 that is associated with the sequence identifier. The memory return control 140 then pops the first memory request from the piggyback FIFO 135 and issues the first memory request, including the response (e.g., data or acknowledgement) received from the memory device 115, to the memory request scheduler 120. In turn, the memory request scheduler 120 issues the memory request with the response to the cache 125 for updating the cache 125 with the response and processing the memory request.

Further, the memory return control 120 pops subsequent memory requests stored in the piggyback FIFO 135 associated with the sequence identifier and issues the subsequent memory requests to the memory request scheduler 120. In turn, the memory request scheduler 120 issues the subsequent memory requests to the cache 125 for processing.

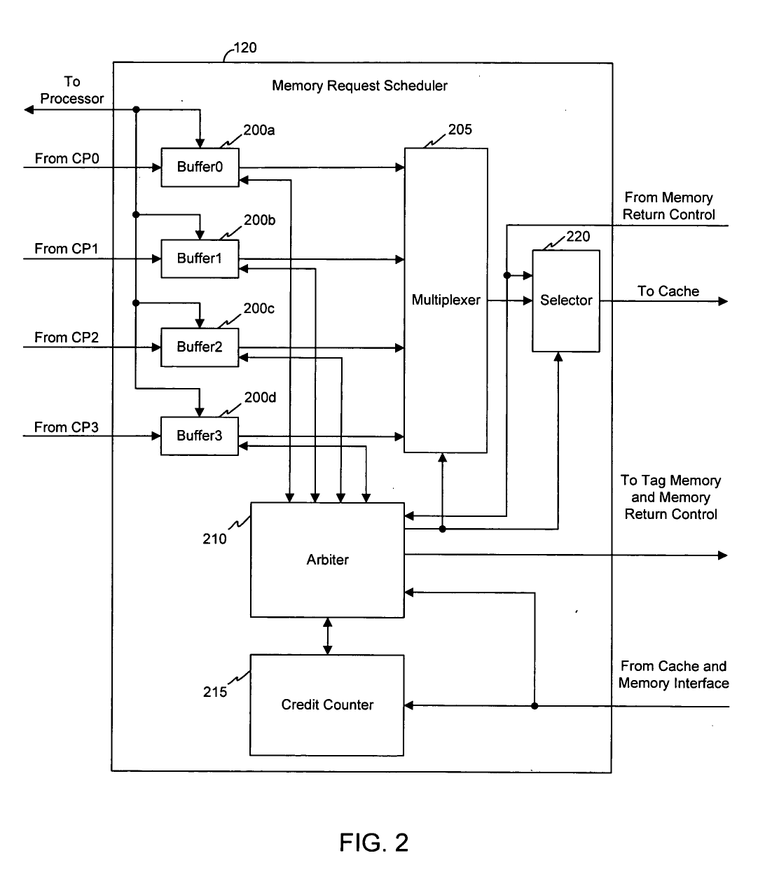

Referring now to FIG. 2, the memory request scheduler 120 of the multiprocess cache system 110 includes one or more buffers 200. Each buffer 200 receives one or more memory requests from one of the computing processes 107 of the processor 105. The buffers 200 can each store one or more memory requests. Additionally, the buffers 200 provide status information to the processor 105 (e.g., the buffer is empty or full). It is to be understood that the buffers 200a-d shown in the figure are exemplary and the present invention is not limited to having any particular number of buffers 200.

The memory request scheduler 120 also includes a multiplexer 205, an arbiter 210, a credit counter 215, and a selector 220. The multiplexer 205 communicates with the buffers 200 and the selector 220. The buffers 200 provide memory requests to the multiplexer 205, and the multiplexer 205 provides these memory requests to the selector 220. The selector 220 receives memory requests from the multiplexer 205 and the memory return control 140, and issues these memory requests to the cache 125, as is explained more fully herein.

The arbiter 210 communicates with the buffers 200, the multiplexer 205, the credit counter 215, and the selector 220. The arbiter 210 determines the order in which the memory requests stored in the buffers will pass through the multiplexer 205 to the selector 220. The arbiter 210 selects one of the memory requests stored in one of the buffers 200 and provides a signal to the multiplexer 205 to pass the selected memory request from the buffer 200 to the selector 220.

As part of this selection process, the arbiter 210 determines if the piggyback FIFO 135 that is to store the memory request is considered full, as is discussed more fully herein. If the piggyback FIFO 135 that is to store the given memory request is considered full, the arbiter 210 will not select the memory request. In one embodiment, however, the arbiter 210 can select another memory request stored in one of the other buffers 200 after determining that the piggyback FIFO 135 that is to store this other memory request is not considered full.

Additionally, the arbiter 210 selects a memory request, received by the selector 220 from either the multiplexer 205 or the memory return control 140, and provides a signal to the selector 220 for the selected memory request. The selector 220 receives the signal from the arbiter 210 and issues the selected memory request to the cache 125. Additionally, the arbiter 210 provides a signal to the buffer 200 storing the selected request or to the memory return control 140, as appropriate, indicating that the selected memory request issued to the cache 125.

The credit counter 215 maintains a count of sequence identifiers (i.e., credits) available for memory requests, as is explained more fully herein. Because each sequence identifier is associated with a piggyback FIFO 135, this also results in maintaining a count of piggyback FIFOs 135 available for memory requests.

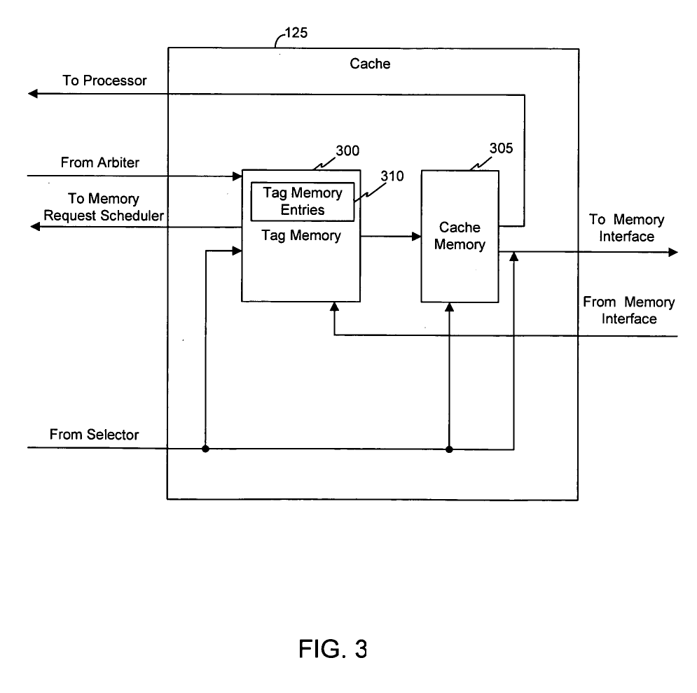

Referring now to FIG. 3, the cache 125 includes a tag memory 300 and a cache memory 305. The tag memory 300 includes tag memory entries 310, one for each line or set of lines in the cache memory 305, as will be explained more fully herein. The tag memory 300 receives a memory request, which can include data or an acknowledgement, from the selector 220 of the memory request scheduler 120 and determines if the data to be accessed by the memory request is in the cache memory 305 (i.e., cache hit). In response to a cache hit, the memory request received from the selector 220 is processed on the cache memory 305. If the data to be accessed by the memory request is not in the cache memory 305 (i.e., cache miss), the cache memory 305 is subsequently updated with data from the memory device 115 before the memory request is processed on the cache memory 305, as is explained more fully herein.

Additionally, the cache memory 305 passes the data stored in the cache memory 305 or an acknowledgement, as appropriate, to the processor 105. Furthermore, the cache memory 305 issues the memory request to the memory interface 130, as is discussed more fully herein.

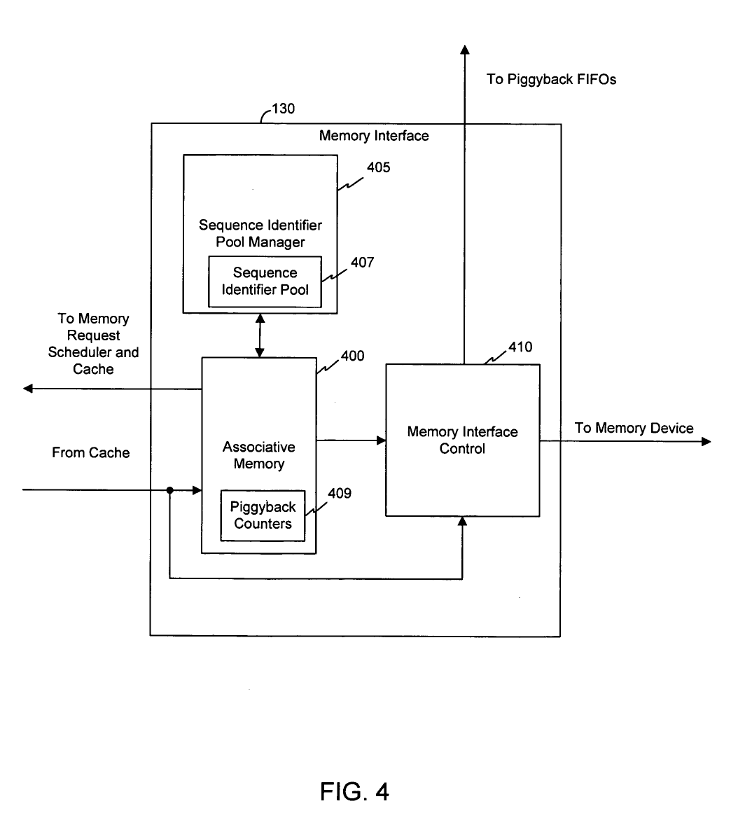

Referring now to FIG. 4, the memory interface 130 includes an associative memory 400 and a sequence identifier pool manager 405. The associative memory 400 receives a memory request from the cache 125 and issues a request to the sequence identifier pool manager 405 for a sequence identifier. The sequence identifier pool manager 405 provides a sequence identifier to the associative memory 400, which issues the memory request received from the cache 125 and the associated sequence identifier to the memory interface control 410. Additionally, the associative memory 400 can issue a request to the sequence identifier pool manager 405 to release a sequence identifier that is associated with the memory request, as is explained more fully herein.

The sequence identifier pool manager 405 manages a sequence identifier pool 407 that holds sequence identifiers, one per piggyback FIFO 135, to be associated with the memory requests. In response to a request for a sequence identifier from the associative memory 400, the sequence identifier pool manger 405 allocates a sequence identifier from the sequence identifier pool 407 and provides the sequence identifier to the associative memory 400. In response to a request from the associative memory 400 to release a sequence identifier, the sequence identifier pool manager 405 returns the sequence identifier to the sequence identifier pool 407, as is explained more fully herein.

The associative memory 400 includes piggyback counters 409, one per piggyback FIFO 135, which are each associated with a piggyback FIFO 135. The piggyback counter 409 counts the number of memory requests stored in the associated piggyback FIFO 135 (i.e., depth count).

The memory interface 130 further includes a memory interface control 410. In response to receiving a memory request and an associated sequence identifier from the associative memory 400, the memory interface control 410 issues an external memory request, which is based on the memory request and includes the sequence identifier, to the memory device 115. Additionally, the memory interface control 410 stores the memory request in the piggyback FIFO 135 that is associated with the sequence identifier.

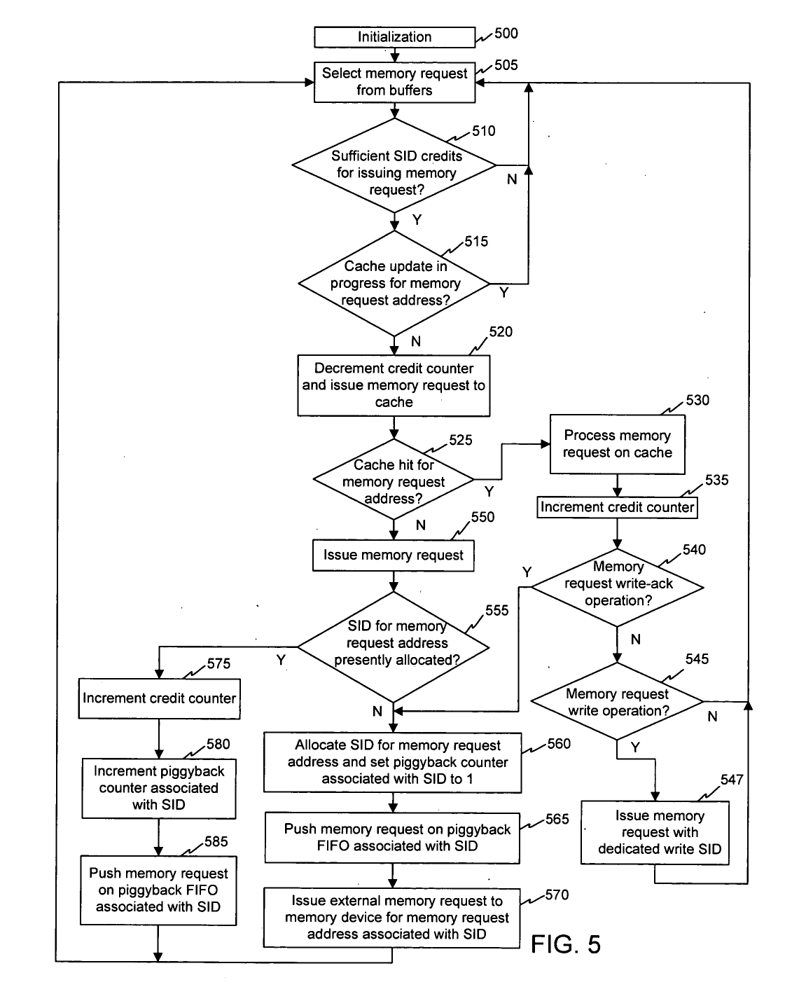

Referring now to FIG. 5, a portion of one method for managing the multiprocess cache system 110 is shown. In step 500, the multiprocess cache system 110 is initialized by setting the credit counter 215 of the memory request scheduler 120 to the number of sequence identifiers in the multiprocess cache system 110, which is based on the number of piggyback FIFOs 135 in the multiprocess cache system 110. Additionally, the piggyback counters 409 of the associative memory 400 are set to zero, indicating that each piggyback FIFO 135 is empty.

In step 505, the arbiter 210 of the memory request scheduler 120 uses a selection algorithm to select a memory request that was issued from a computing process 107 of the processor 105 to a buffer 200 of the memory request scheduler 120. For example, the selection algorithm can be a round robin algorithm.

As part of this selection process, the arbiter 210 obtains the depth count from the piggyback counter 409 associated with the piggyback FIFO 135 that is to store the memory request. If the depth count for the piggyback FIFO 135 is equal to a threshold value, the piggyback FIFO 135 is considered full, and the arbiter 210 will not select that memory request. In one embodiment, however, the arbiter 210 can select another memory request stored in one of the other buffers 200 after determining that the piggyback FIFO 135 that is to store this other memory request is not considered full.

In one embodiment of the multiprocess cache system 110, the threshold value is set equal to the size of a piggyback FIFO 135 less the number of pipeline stages (each of which can contain a memory request) in the cache 125 and the memory interface 130. Further, in this embodiment, if the depth count of any one of the piggyback counters 135 is equal to the threshold value, all of the piggyback FIFOs 135 are considered full and the arbiter 210 will not select any memory requests from the buffers 200 of the memory request scheduler 120.

In step 510, the arbiter 210 of the memory request scheduler 120 communicates with the credit counter 215 to determine if there are sufficient sequence identifiers (i.e., credits) available for issuing the selected memory request to the cache 125. The number of sequence identifiers and associated piggyback FIFOs 135 to be used for a memory request depends upon the type of the memory request. For example, a memory request for a write-through-ack operation may require one sequence identifier and associated piggyback FIFO 135 for a read operation to update the cache 125 with data from the memory device 115 and store write data in the cache 125, and another sequence identifier and associated piggyback FIFO 135 for a write-ack operation to store the write data to the memory device 115 and receive an acknowledgment from the memory device 115. If sufficient sequence identifier credits are available for issuing the selected memory request, then the method proceeds to step 515, otherwise the method returns to step 505.

In step 515, the arbiter 210 checks the tag memory 300 of the cache 125 to determine if a cache update is in progress for previous memory requests to the same memory address as the selected memory request. As is explained more fully herein, a tag memory entry 310 in the tag memory 300 of the cache 125 for the memory address of previous memory requests is disabled during a cache update for the previous memory requests. If the tag memory entry 310 for the memory address of the selected memory request is enabled in the tag memory 300, then the method proceeds to step 520, otherwise the method returns to step 505.

In step 520, the arbiter 210 of the memory request scheduler 120 decrements the credit counter 215 by the number of sequence identifiers to be used for the memory request to reserve the number of sequence identifiers for the memory request. This also results in the number of piggyback FIFOs 135 being reserved for the memory request, as is explained more fully herein. Additionally, the arbiter 210 provides a signal to the multiplexer 205 to pass the selected memory request from the buffer 200 storing the selected memory request to the selector 220. The arbiter 210 also provides a signal to the selector 220 to issue the selected memory request to the cache 125.

Also in step 520, the arbiter 210 provides a signal to the buffer 200 storing the selected memory request, indicating that the memory request issued to the cache 125. The buffer 200 can then remove the selected memory request from the buffer 200.

In step 525, the tag memory 300 of the cache 125 receives the memory request from the selector 220 and compares the memory address of the memory request with the tag memory entries 310 to determine if the data is in the cache memory 305. If the data is in the cache memory 305 (i.e., cache hit), the method proceeds to step 530. If the data is not in the cache memory 305 (i.e., cache miss), then the method proceeds to step 550.

In step 530, the memory request received from the selector 220 is processed on the cache 125. Additionally, the cache 125 updates the status of the memory request. For example, the memory request can have status bits (e.g., a cookie) to indicate the status of the memory request, and the cache memory 305 can modify the status bits to update the status of the memory request.

In response to receiving a read memory request for a read operation from the selector 220, the cache memory 305 provides the data, which is stored in the cache memory 305, and a completion signal to the computing process 107 of the processor 105 that issued the memory request. Additionally, the cache memory 305 modifies the status bits of the memory request to indicate that the memory request is complete and issues the memory request to the associative memory 400 of the memory interface 130.

In response to receiving a write-back memory request from the selector 220, the cache memory 305 is updated with write data, which is included in the memory request, and the tag memory 300 is updated to reflect the write data stored in the cache memory 305. Additionally, the cache memory 305 of the cache 125 provides a completion signal to the computing process 107 of the processor 105 that issued the memory request. Further, the cache memory 305 modifies the status bits of the memory request to indicate that the memory request is complete and issues the memory request to the associative memory 400 of the memory interface 130.

In response to receiving a write-through memory request for a write operation from the selector 220, the cache memory 305 is updated with write data, which is included in the memory request, and the tag memory 300 is updated to reflect the write data stored in the cache memory 305. Additionally, the cache memory 305 provides a completion signal to the computing process 107 of the processor 105 that issued the memory request. Further, the cache memory 305 issues the memory request to the associative memory 400 of the memory interface 130.

In response to receiving a write-through-ack memory request for a write-ack operation from the selector 220, the cache memory 305 is updated with write data, which is included in the memory request, and the tag memory 300 is updated to reflect the write data stored in the cache memory 305. Additionally, the cache memory 305 issues the memory request to the associative memory 400 of the memory interface 130.

In step 535, the tag memory 300 increments the credit counter 215 of the memory request scheduler 120 to release a sequence identifier for the memory request, which has now been processed on the cache memory 305.

In step 540, the cache memory 305 determines if the memory request is for a write-ack operation. If the memory request is for a write-ack operation, then the method proceeds to step 560, otherwise the method proceeds to step 545.

In step 545, the cache memory 305 determines if the memory request is for a write operation. If the memory request is for a write operation, then the method proceeds to step 547, otherwise the method returns to step 505.

In step 547, the associative memory 400 of the memory interface 130 receives the memory request for a write-operation from the cache 125 and associates a dedicated write sequence identifier with the memory request. The dedicated write sequence identifier is a sequence identifier that is not associated with a piggyback FIFO 135 and that is not associated with the memory address of the memory request. For example, the dedicated write sequence identifier can be a common sequence identifier that is shared between write-through memory requests, which can have different memory addresses. The dedicated write sequence identifier indicates that write data in the memory request is to be stored in the memory device 115, but that the memory device 115 need not return a response (e.g., acknowledgement) to the memory return control 140. The method then returns to step 505.

In step 550, arrived at from the determination in step 525 that there was no cache hit (i.e., cache miss), the cache memory 305 modifies the status bits of the memory request to a read operation to indicate that the memory request generated a cache miss, and issues the memory request to the memory interface 130.

In step 555, the associative memory 400 in the memory interface 130 receives the memory request from the cache 125 and determines if a sequence identifier is presently allocated for the memory address of the memory request. For example, the associative memory 400 can search a content addressable memory that stores the memory addresses of the outstanding memory requests together with the sequence identifiers associated with the memory addresses. If the associative memory 400 determines that address of the memory request received from the cache 125 does not match the memory address of an outstanding memory request, then the method proceeds to step 560, otherwise the method proceeds to step 575.

In step 560, arrived at either from the determination in step 540 that the memory request is for a write-ack operation, or from the determination in step 555 that address of the memory request received from the cache 125 does not match the memory address of an outstanding memory request, the associative memory 400 issues a sequence identifier request to the sequence identifier pool manager 405 for the memory request received from the cache 125. The sequence identifier pool manager 405 receives the sequence identifier request from the associative memory 400, allocates a sequence identifier from the sequence identifier pool 407, and provides the sequence identifier to the associative memory 400.

In response to receiving the sequence identifier from the sequence identifier pool manager 405, the associative memory 400 associates the sequence identifier with the memory address of the memory request. For example, the associative memory 400 can store the sequence identifier together with the memory address of the memory request in a content addressable memory. In this way, the associative memory 400 also associates the memory request received from the cache 125 with the sequence identifier. Additionally, the associative memory 400 sets the piggyback counter 409 associated with the sequence identifier to one because the memory request will be the first memory request stored in the piggyback FIFO 135 associated with the sequence identifier. Further, the associative memory 400 issues the memory request and provides the sequence identifier to the memory interface control 410.

In step 565, the memory interface control 410 receives the memory request and the associated sequence identifier from the associative memory 400. If the sequence identifier is not the dedicated write sequence identifier, the memory interface control 410 pushes the memory request (i.e., stores the memory request) on the piggyback FIFO 135 associated with the sequence identifier.

In step 570, the memory interface control 410 issues an external memory request to the memory device 115 for the memory request and associated sequence identifier received from the associative memory 400. The external memory request is based on the memory request received from the associative memory 400 and includes the sequence identifier associated with the memory request. In response to the external memory request, the memory device 115 processes the external memory request and can provide a response to the memory return control 140. In response to an external memory request for a read operation, the memory device 115 provides data and the sequence identifier to the memory return control 140. In response to an external memory request for a write operation associated with the dedicated write sequence identifier, the memory device 115 stores write data of the memory request in the memory device 115. In response to an external memory request for a write-ack operation, the memory device 115 stores write data of the memory request in the memory device 115 and provides an acknowledgement and the sequence identifier to the memory return control 140. The method then returns to step 505.

In step 575, arrived at from the determination in step 555 that a sequence identifier is presently allocated for the memory address of the memory request received from the cache 125, the associative memory 400 of the memory interface 130 increments the credit counter 215 of the memory request scheduler 120 to release the sequence identifier that was reserved for the memory request. The sequence identifier that was reserved for the memory request is no longer needed for the memory request because the memory address is to be associated with the sequence identifier presently allocated for the memory address.

In step 580, the associative memory 400 identifies the sequence identifier associated with the memory request received from the cache 125 and increments the piggyback counter 409 associated with the sequence identifier. By incrementing the piggyback counter 409 associated with the sequence identifier, a location is reserved for storing the memory request in the piggyback FIFO 135 associated with the sequence identifier.

In step 585, the memory interface control 410 receives the memory request and the associated sequence identifier from the associative memory 400 and pushes the memory request (i.e., stores the memory request) on the piggyback FIFO 135 associated with the sequence identifier. The method then returns to step 505.

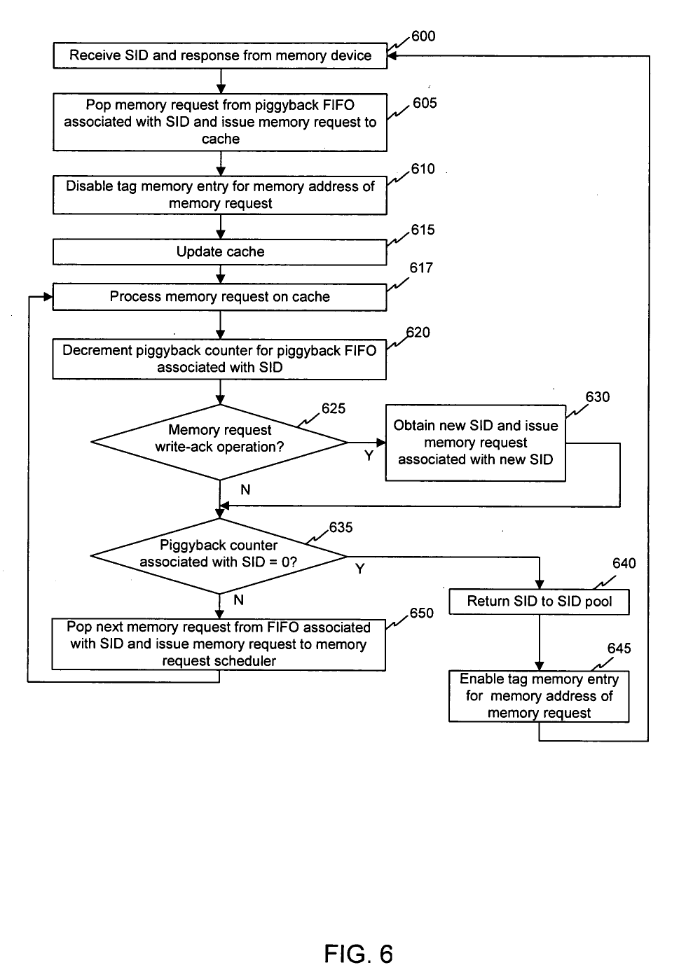

Referring now to FIG. 6, a portion of the method for managing the multiprocess cache system 110 is shown. In step 600, the memory return control 140 of the multiprocess cache system 110 receives a sequence identifier together with a response (e.g., data or an acknowledgement) from the memory device 115.

In step 605, the memory return control 140 selects the piggyback FIFO 135 associated with the sequence identifier received from the memory device 115 and pops the memory request (i.e., retrieves the first memory request) from the piggyback FIFO 135. The memory return control 140 then issues the memory request and the associated response (e.g., data or acknowledgement) received from the memory device 115 to the memory request scheduler 120.

Also in step 605, the arbiter 210 selects the memory request received by the selector 220 from the memory return control 140 and provides signals to the selector 220 to issue the memory request and the associated response (e.g., data or acknowledgement) received from the memory request control 140 to the cache 125.

In step 610, the tag memory 300 of the cache 125 receives the memory request from the selector 220 and disables the tag memory entry 310 in the tag memory 300 for the memory address of the memory request. For example, the tag memory 300 can have tag memory entries 310, each of which maps one or more memory addresses to a cache line in the cache memory 305 (i.e., direct-mapped cache), and the tag memory 300 can disable the tag memory entry 310 for the memory request.

In step 615, the cache memory 305 receives the memory request and the associated response of the memory request (e.g., data) from the selector 220 and updates the cache 125 with the response. In response to receiving a memory request (e.g., read memory request, write-back memory request, write-through memory request, or write-through-ack memory request) for a read operation from the selector 220, the cache memory 305 of the cache 125 is updated with the data contained in the response, and the tag memory 300 is updated to reflect the data stored in the cache memory 305.

In step 617, the memory request is processed on the cache 125. In response to receiving a read memory request for a read operation from the selector 220 of the memory request scheduler 120, the cache memory 305 of the cache 125 provides the data and a completion signal to the computing process 107 of the processor 105 that issued the memory request. Additionally, the cache memory 305 modifies the status bits of the memory request to indicate that the memory request is complete and issues the memory request to the associative memory 400 of the memory interface 130.

In response to receiving a write-back memory request from the selector 220 for a read operation, the cache memory 305 of the cache 125 is updated with write data, which is included in the memory request, and the tag memory 300 is updated to reflect the write data stored in the cache memory 305. Additionally, the cache memory 305 of the cache 125 provides a completion signal to the computing process 107 of the processor 105 that issued the memory request. Further, the cache memory 305 modifies the status bits of the memory request to indicate that the memory request is complete and issues the memory request to the associative memory 400 of the memory interface 130.

In response to receiving a write-through memory request from the selector 220 for a read operation, the cache memory 305 of the cache 125 is updated with write data, which is included in the memory request, and the tag memory 300 is updated to reflect the write data stored in the cache memory 305. Additionally, the cache memory 305 provides a completion signal to the computing process 107 of the processor 105 that issued the memory request. Further, the cache memory 305 modifies the status bits of the memory request to indicate a write operation and issues the memory request to the associative memory 400 of the memory interface 130.

In response to receiving a write-through-ack memory request from the selector 220 for a read operation (i.e., the first cycle of a write-through-ack memory request), the cache memory 305 of the cache 125 is updated with write data, which is included in the memory request, and the tag memory 300 is updated to reflect the write data stored in the cache memory 305. Additionally, the cache memory 305 modifies the status bits of the memory request to indicate that the memory request is a write-ack operation (i.e., the second cycle of a write-through-ack memory request) and issues the memory request to the associative memory 400 of the memory interface 130.

In response to receiving a write-through-ack memory request from the selector 220 for a write-ack operation (i.e., the second cycle of a write-through-ack memory request), the cache memory 305 provides a completion signal to the computing process 107 of the processor 105 that issued the memory request. The completion signal serves as an acknowledgment to the computing process 107 that issued the memory request. Additionally, the cache memory 305 modifies the status bits of the memory request to indicate that the memory request is complete and issues the memory request to the associative memory 400 of the memory interface 130.

In step 620, the associative memory 400 of the memory interface 130 receives the memory request from the cache memory 305 of the cache 125 and identifies the sequence identifier associated with the memory request (e.g., locates the sequence identifier in a content addressable memory). If the status bits of the memory request indicate that the memory request is complete, the associative memory 400 decrements the piggyback counter 409 associated with the sequence identifier to complete the memory request. If the status bits of the memory request indicate that the memory request is a write-ack operation (i.e., the second cycle of a write-through-ack memory request), the associative memory 400 decrements the piggyback counter 409 associated with the sequence identifier to complete the read operation (i.e., the first cycle of a write-through-ack memory request) of the memory request. By decrementing the piggyback counter 409 associated with the sequence identifier, an entry in the piggyback FIFO 135 associated with the sequence identifier is released for the completed memory request.

In step 625, associative memory 400 checks the status bits of the memory request received from the cache 125 to determine if the memory request is for a write-ack operation. If the associative memory 400 determines that the memory request is for a write-ack operation then the method proceeds to step 630, otherwise the method proceeds to step 635.

In step 630, the associative memory 400 obtains a sequence identifier (i.e., new sequence identifier) from the sequence identifier pool manager 405 for the memory request, as is described more fully herein. The associative memory 400 then issues the memory request for a write-ack operation (i.e., the second cycle of a write-through-ack memory request) and the associated sequence identifier to the memory interface control 410 for processing, as is described more fully herein. The method then proceeds to step 635.

In step 635, arrived at from the determination in step 625 that the memory request is not for a write-ack operation, or from step 630, in which the associative memory issues a memory request with a new sequence identifier for a write-ack operation to the memory interface control 410, the associative memory 400 determines if the piggyback counter 409 associated with the sequence identifier of the memory request received from the cache 125 is set to zero, indicating that the piggyback FIFO 135 associated with the sequence identifier is now empty. If the piggyback counter FIFO 135 associated with the sequence identifier is empty, the method proceeds to step 640, otherwise the method proceeds to step 650.

In step 640, the associative memory 400 issues a sequence identifier request to the sequence identifier pool manager 405 to release the sequence identifier associated with the memory address of the memory request because all outstanding memory requests associated with the sequence identifier are now complete. In response to receiving the sequence identifier request from the associative memory 400, the sequence identifier pool manager 405 returns the sequence identifier to the sequence identifier pool 407 and provides a signal to the associative memory 400 indicating that the sequence identifier has been released.

In step 645, associative memory 400 of the memory interface 130 provides a signal to the tag memory 300 of the cache 125 to enable the tag memory entry 310 of the tag memory 300 of the cache 125 for the memory address of the memory request. Once the tag memory entry 310 for the memory address is enabled, the selector 220 of the memory request scheduler can now issue to the cache 125 additional memory requests to the memory address. The method then returns to step 600.

In step 650 arrived at from the determination in step 635 that the piggyback FIFO 135 associated with the sequence identifier of the memory request is not empty, the memory return control 140 pops the next memory request (i.e., subsequent memory request) from the piggyback FIFO 135 associated with the sequence identifier and issues the memory request to the selector 220 of the memory request scheduler 120. The memory request scheduler 120 then issues the memory request to the cache 125 in essentially the same manner as the previous memory request. The method then returns to step 617.

The embodiments discussed herein are illustrative of the present invention. As these embodiments of the present invention are described with reference to illustrations, various modifications or adaptations of the methods and/or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

For example, in one embodiment of the multiprocess cache system 110, the processor 105 is a first level cache and the multiprocess cache system 110 is a second level cache. For this embodiment, the computing process 107 of the processor 105 is a memory request in first level cache. In response to a cache miss in the first level cache (i.e., first level cache miss), the first level cache issues the memory request to the multiprocess cache system 110 (i.e., second level cache).

As another example, in one embodiment of the multiprocess cache system 110, the multiprocess cache system 110 is a first level cache and the memory device 115 is a second level cache. As a further example, in one embodiment of the multiprocess cache system 110, the cache 125 translates a memory address of a memory request received from the memory request scheduler 120 into a virtual memory address and replaces the memory address of the memory request with the virtual memory address. For example, the virtual memory address can be a segmented memory address. The cache 125 then uses the virtual memory address to access the tag memory 300 and cache memory 305 of the cache 125. Additionally, the cache 125 uses the virtual memory address to issue the memory request to the memory interface 130.

As still another example, in one embodiment of the multiprocess cache system 110, a memory request can be a bypass-cache memory request. The bypass-cache memory request is issued from the selector 220 of the memory request scheduler 120 to the memory interface control 410 of the memory interface 130. The memory interface control 410 accesses the data in the memory device 115 for the by-pass memory request and provides the data or an acknowledgement to computing process 107 of the processor 105 that issued the bypass-cache memory request.

1. A method for managing a cache, the method comprising the steps of:
receiving a first memory request to a memory address from a first computing process;
associating a first sequence identifier with the first memory request;
receiving a second memory request to the memory address from a second computing process;
associating the first sequence identifier with the second memory request;
issuing a first external memory request with the first sequence identifier to a memory device;
receiving data and the first sequence identifier from the memory device in response to the first external memory request;
associating the data with the first memory request based on the first sequence identifier received from the memory device; and
updating the cache with the data for the first memory request.

2. A method as recited in claim 1, wherein the first computing process is the second computing process.

3. A method as recited in claim 1, further comprising the step of processing the first memory request on the cache.

4. A method as recited in claim 1, further comprising the step of processing the second memory request on the cache.

5. A method as recited in claim 1, further comprising the step of providing the data to the first computing process for the first memory request.

6. A method as recited in claim 1, further comprising the step of providing the data to the second computing process for the second memory request.

7. A method as recited in claim 1, further comprising the steps of:
issuing a second external memory request to the memory device for the first memory request;
associating a second sequence identifier with the first memory request;
receiving an acknowledgement and the second sequence identifier from the memory device in response to the second external memory request;
associating the acknowledgment with the first memory request based on the second sequence identifier received from the memory device; and
providing the acknowledgement to the first computing process for the first memory request.

8. A method as recited in claim 1, further comprising the steps of:
issuing a second external memory request to the memory device for the second memory request;
associating a second sequence identifier with the second memory request;
receiving an acknowledgement and the second sequence identifier from the memory device in response to the second external memory request;
associating the acknowledgment with the second memory request based on the second sequence identifier received from the memory device; and
providing the acknowledgement to the second computing process for the second memory request.

9. A method as recited in claim 1, wherein the memory address is a virtual memory address.

10. A method as recited in claim 1, wherein the first and second computing processes are process threads.

11. A method as recited in claim 1, further comprising the steps of:
receiving a plurality of second memory requests to the memory address from a corresponding plurality of computing processes;
associating the first sequence identifier with each second memory request; and
processing the second memory requests on the cache based on the first sequence identifier received from the memory device.

12. A method as recited in claim 1, wherein the first memory request is processed on the cache before the second memory request is processed on the cache.

13. A method as recited in claim 11, wherein the second memory requests are issued to the cache in the order the second memory requests are received.

14. A system for memory management of a cache, wherein the cache receives a first memory request to a memory address from a first computing process and a second memory request to the memory address from a second computing process, the system comprising:
an associative memory configured to associate the first memory request with a first sequence identifier and for associating the second memory request with the first sequence identifier;
a memory interface control configured to issue an external memory request with the first sequence identifier to a memory device; and
a memory return control configured to receive data and the first sequence identifier from the memory device in response to the external memory request, associate the data with the first memory request based on the first sequence identifier received from the memory device, and the update cache with the data for the first memory request.

15. A system as recited in claim 14, further comprising a sequence identifier pool manager configured to allocate the first sequence identifier from a sequence identifier pool and provide the first sequence identifier to the associative memory.

16. A system as recited in claim 15, wherein the sequence identifier pool manager is further configured to receive the first sequence identifier from the associative memory and return the first sequence identifier to the sequence identifier pool.

17. A system as recited in claim 14, wherein the memory return control is further configured to issue the second memory request to the cache for processing based on the first sequence identifier received from the memory device.

18. A system as recited in claim 14, wherein the memory return control is further configured to return the data to the first computing process based on the first sequence identifier received from the memory device.

19. A system as recited in claim 14, wherein the memory return control is further configured to return the data to the second computing process based on the first sequence identifier received from the memory device.

20. A system as recited in claim 14, wherein:
the associative memory is further configured to associate a second sequence identifier with the first memory request;
the memory interface is further configured to issue a second external memory request with the second sequence identifier to the memory device for the first memory request; and
the memory return control is further configured to receive an acknowledgement and the second sequence identifier from the memory device in response to the second external memory request and return the acknowledgement to the first computing process for the first memory request based on the second sequence identifier received from the memory device.

21. A system as recited in claim 14, wherein:
the associative memory is further configured to associate a second sequence identifier with the second memory request;
the memory interface is further configured to issue a second external memory request with the second sequence identifier to the memory device for the second memory request; and
the memory return control is further configured to receive an acknowledgement and the second sequence identifier from the memory device in response to the second external memory request and return the acknowledgement to the second computing process for the second memory request based on the second sequence identifier received from the memory device.

22. A system as recited in claim 14, wherein the associative memory is a content addressable memory.

23. A system as recited in claim 14, wherein the cache receives a plurality of second memory requests to the memory address;
the associative memory is further configured to associate the first sequence identifier with each second memory request; and
the memory return control is further configured to issue the second memory requests to the cache based on the second sequence identifier received from the memory device.

24. A system as recited in claim 14, wherein the memory address is a virtual memory address.

25. A system as recited in claim 14, wherein the first computing process is the second computing process.

26. A system as recited in claim 14, further comprising a piggyback FIFO associated with the first sequence identifier and configured to store the first and second memory requests associated with the first sequence identifier.

27. A system as recited in claim 14, wherein the cache is a first level cache.

28. A system as recited in claim 14, wherein the cache is a second level cache.

29. A system as recited in claim 14, wherein the first memory request and second memory requests are process threads.

30. A computing system comprising:
a processor for issuing a first memory request to a memory address and a second memory request to the memory address;
a memory device;
a cache;
an associative memory configured to associate a sequence identifier with the first memory request and the second memory request;
a memory interface control configured to issue an external memory request with the sequence identifier to the memory device; and
a memory return control configured to receive data and the sequence identifier from the memory device in response to the external memory request and to update the cache with the data based on the sequence identifier received from the memory device.

31. A computing system as recited in claim 30 wherein the memory return control is further configured to associate the data with the first memory request based on the sequence identifier received from the memory device and to issue the first memory request to the cache for processing.

32. A computing system as recited in claim 30, further comprising a piggyback FIFO associated with the sequence identifier and configured to store the first memory request and the second memory request.

33. A computing system as recited in claim 30, wherein the processor is a microprocessor.

34. A computing system as recited in claim 30, wherein the processor is a multithreaded processor.

35 A computing system as recited in claim 30, wherein the processor comprises a plurality of execution pipelines for generating the first and second memory requests.

36. A computing system as recited in claim 30, wherein the processor includes a first computing process configured to issue the first memory request and a second computing process configured to issue the second memory request.

37. A computing system as recited in claim 36, wherein the first computing process is the second computing process.

38. A computing system as recited in claim 36, wherein the first computing process and the second computing process are process threads.

39. A computing system as recited in claim 30, wherein:
the processor is further configured to generate a plurality of second memory requests;
the associative memory is further configured to associate the sequence identifier with each second memory request; and
the memory return control is further configured to issue the second memory requests to the cache for processing, based on the sequence identifier received from the memory device.

40. A computing system as recited in claim 30, wherein the processor is a first level cache and the cache is a second level cache.

41. A computing system as recited in claim 30, wherein the cache is a first level cache and the memory device is a second level cache.

42. A system for managing a cache, the system comprising:
a means for receiving a first memory request to a memory address and a second memory request to the memory address;
a means for associating a sequence identifier with the first memory request and the second memory request;
a means for issuing an external memory request with the sequence identifier for the first memory request;
a means for receiving data and the sequence identifier in response to the external memory request;
a means for associating the data with the first memory request based on the sequence identifier received in response to the external memory request.

43. A system as recited in claim 42, further comprising a means for updating the cache with the data.

44. A system as recited in claim 42, further comprising a means for processing the first memory request on the cache based on the received sequence identifier.

45. A system as recited in claim 42, further comprising a means for processing the second memory request on the cache based on the received sequence identifier.
